(19) United States
(12) Patent Application Publication
(10) Pub. No.: US 2006/0166857 A1
(43) Pub. Date: Jul. 27, 2006

(54) 4,8-Dimethyl-7-nonen-2-one and 4,8-dimethylnonan-2-one used as perfumes

(76) Inventors: Horst Surburg, Holzminden (DE); Ute Rohde, Holzminden (DE); Oskar Koch, Gottingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/563,875

(22) PCT Filed: Jun. 15, 2004
(86) PCT No.: PCT/EP04/51112

§ 371 Date: Jan. 9, 2006

(30) Foreign Application Priority Data
Jul. 9, 2003 (DE) 103 30 865.2

(51) Int. Cl. A61Q 13/00

(52) U.S. Cl. 512/25

(57) ABSTRACT

The use of 4,8-dimethyl-7-nonen-2-one and 4,8-dimethylnonan-2-one as fragrances with a rose odour is described. Corresponding perfume compositions, perfumed products and processes for producing or strengthening a rose odour are also described.

The present invention relates to the use of 4,8-dimethyl-7-nonen-2-one, 4,8-dimethylnonan-2-one or a mixture of these compounds as fragrances.

There is a general need for rose fragrances in the perfume industry because consumers are constantly looking for new and modern rose-scented perfumes. Fragrances with a rose odour are used in large quantities and innumerable variations in perfumes, mixtures of fragrances (perfume compositions) and perfume formulations for a very wide variety of fields of application.

The known rose fragrances include the compounds geraniol (3,7-dimethyl-2,6-octadien-1-ol) and citronellol (3,7-dimethyl-2-octen-1-ol), but it has now emerged that many people have intolerance reactions, e.g. allergic reactions, to these compounds.

The perfume industry therefore has not only a general need for other rose fragrances, but also a specific need for rose fragrances that do not possess said negative toxicological properties and are advantageously capable of replacing the rose fragrances geraniol and citronellol commonly used hitherto in perfume compositions.

The object of the present invention was to provide rose fragrances which match said profile of requirements. The search for suitable rose fragrances that led to the present invention was complicated by the following facts:
The mechanisms of odour perception are not sufficiently well known.
The relationships between the specific odour perception, on the one hand, and the chemical structure of the corresponding fragrance, on the other, have not been adequately researched.
Even very slight changes in the structural composition of a known fragrance frequently cause major changes in the sensory properties and impair the human organism's tolerance.

The success of the search for suitable rose fragrances therefore depends substantially on intuition.

It has now been found, surprisingly, that the compounds 4,8-dimethyl-7-nonen-2-one and 4,8-dimethylnonan-2-one are suitable for achieving the aforesaid object.

The two compounds mentioned each have a rose-like odour and properties in application technology which enable them to be used in perfume compositions in place of the conventional (but allergenic) rose fragrances geraniol and citronellol. The match between the olfactory profiles of geraniol and citronellol, on the one hand, and 4,8-dimethyl-7-nonen-2-one and 4,8-dimethylnonan-2-one, on the other, is surprising because the latter compounds are not primary alcohols but ketones, i.e. substances with a functionality very different from that of primary alcohols. Normally, such substantial differences in the functional groups of compounds lead to very different sensory properties, even if they are otherwise structurally similar.

There has so far been no sensory description of the compound 4,8-dimethylnonan-2-one. Although an olfactory description of the compound 4,8-dimethyl-7-nonen-2-one has been disclosed in Indian Perfumer 22 (4), pages 225-228 (1978), it reads: “coconut, rose-like”, so it had to be assumed that 4,8-dimethyl-7-nonen-2-one is not suitable as a substitute for geraniol and citronellol, because although the disclosure in Indian Perfumer confirms a rose-like olfactory character, this observation was coupled with the further observation that a primary coconut-like odour is present. Our own experiments have now shown, surprisingly, that the olfactory description given in Indian Perfumer is not correct. In fact, a coconut-like odour cannot be observed in the sensory examination of 4,8-dimethyl-7-nonen-2-one; rather, the compound has a radiantly rose-like, fruity, natural odour reminiscent of tea roses and for this very reason is outstandingly suitable as a substitute for geraniol and citronellol. The same applies to the compound 4,8-dimethylnonan-2-one, which has a freshly citronellol-like, rose-like odour reminiscent of citronellol oil.

The present invention relates especially to the use of 4,8-dimethyl-7-nonen-2-one, 4,8-dimethylnonan-2-one or a mixture of these compounds for imparting a rose odour that is not accompanied by a coconut olfactory note. In particular, said compounds or mixtures thereof can be used to prepare a perfume composition with a rose odour that is not accompanied by a coconut olfactory note.

In respect of 4,8-dimethylnonan-2-one, however, the invention also relates quite generally to its use as a fragrance.

Interestingly, in contrast to the compounds 4,8-dimethyl-7-nonen-2-one and 4,8-dimethylnonan-2-one, the corresponding α,β-unsaturated ketone, 4,8-dimethyl-3,7-nonadien-2-one, has more of a citrus-like odour that does not qualify it as a substitute for geraniol and citronellol.

The present invention further relates to perfume compositions with a rose odour, comprising
an organoleptically effective amount of 4,8-dimethyl-7-nonen-2-one, 4,8-dimethylnonan-2-one or a mixture of these compounds
   and
at least one other fragrance.

The other fragrance(s) can be selected especially from the following groups I and II, of which group I comprises rose fragrances in the narrower sense, whereas group II comprises substances which do not themselves have a rose note but give good effects in rose combinations, e.g. vanillin and the like, and musk fragrances. Compounds having a sensitizing/allergizing effect, and natural products containing such compounds, are underlined in groups I and II. The use of these compounds is less preferred.

Group I:

geranyl formate; geranyl acetate; geranyl propionate; geranyl isobutyrate; geranyl butyrate; geranyl isovalerate; geranyl tiglate; geranyl benzoate; citronellyl formate; citronellyl acetate; citronellyl propionate; citronellyl isobutyrate; citronellyl butyrate; citronellyl isovalerate; citronellyl tiglate; citronellyl benzoate; phenylethyl alcohol; phenylacetaldehyde; phenylacetaldehyde dimethyl acetal; phenylethyl formate; phenylethyl acetate; phenylethyl propionate; phenylethyl isobutyrate; phenylethyl butyrate; phenylethyl pivalate; phenylethyl isovalerate; phenylethyl 2-ethylbutyrate; phenylethyl tiglate; phenylethyl benzoate; phenylethylphenyl acetate; 2-phenoxyethyl isobutyrate; geranyl methyl ether; rose oxide; phenylethyl methyl ether; phenylethyl ethyl ether; phenylethyl isoamyl ether; 2-methoxybenzyl ethyl ether; α-trichloromethylbenzyl acetate; α,3,3-trimethylcyclohexanemethyl acetate; 2,4,6-trimethyl-3-cyclohexenemethanol; 2-ethylhexanoic acid N,N-diethylamide; 3,7-dimethyloctanol; geranylacetone; linalool; 3,7-dimethyl-1,6-nonadien-3-ol; nerolidol; farnesol; 9-decenol; 9-decenyl acetate; decanal; 10-undecanal; 10-undecenol; citronellyloxyacetaldehyde; 3,7-dimethyloctanylacetaldehyde; 2-methyl-5-phenylpentanol; 2-methyl-5-phenylpentanal; 3-methyl-5-phenylpentanol; benzophenone; diphenyl ether; diphenylmethane; α-damascone; β-damascone; δ-damascone; γ-damascone; β-damascenone; 1-(2,4,4-trimethyl-2-cyclohexenyl)-2-buten-1-one; rose oil; rose absolute; geranium oil.

Group II:

palmarosa oil; lemon oil; patchouli oil; clove oil; ylang-ylang oil; jasmine absolute; ethyl 2,3,6-trimethylcyclohexyl carbonate; hexanal; heptanal; octanal; nonanal; hexanol; heptanol; octanol; nonanol; decanol; undecanol; dodecanol; hexyl acetate; heptyl acetate; octyl acetate; nonyl acetate; decyl acetate; undecyl acetate; dodecyl acetate; benzyl acetate; benzyl butyrate; benzyl benzoate; methylphenyl acetate; ethylphenyl acetate; alpha-terpineol; 4,4a,5,9b-tetrahydro-2,4-dimethylindeno[1,2-d]-m-dioxin; 4,4a,5,9b-tetrahydroindeno[1,2-d]-m-dioxin; ethyl 2-ethyl-6,6-dimethyl-2-cyclohexenecarboxylate; ethyl 2,3,6,6-tetramethyl-2-cyclohexenecarboxylate; ethyl safranate; methyl 6,6-dimethyl-2-methylenecyclohexanecarboxylate; eugenol; isoeugenol; lavender oil; guaiacum wood oil; alpha-ionone; beta-ionone; cinnamyl alcohol; 3-phenylpropanol; cinnamyl acetate; 3-phenylpropyl acetate; alpha-irone; cis-3-hexenol; cis-3-hexenyl acetate; cis-3-hexenyl isobutyrate; vanillin; ethylvanillin; heliotropin; coumarin; ambrinol; indole; 3a,6,6,9a-tetramethyldodecahydronaphtho[2,1-b]furan; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone.

Normally, not only one other fragrance is present, but two, three or more other fragrances.

As already mentioned, the compounds 4,8-dimethyl-7-nonen-2-one and 4,8-dimethylnonan-2-one and mixtures thereof are particularly suitable for creating perfume compositions with a dominant rose odour. Accordingly, the at least one other fragrance is preferably also selected from the group of fragrances with a rose odour. Examples of such fragrances with a rose odour are those of group I above.

Of course, it is also the case in this context that conventionally not only one other rose fragrance is used, but two, three or more.

The compounds 4,8-dimethyl-7-nonen-2-one and 4,8-dimethylnonan-2-one have a negligible allergenic potential. Accordingly, it is normally advantageous not to combine them in perfume compositions with fragrances that do possess allergenic properties. Conventionally, therefore, a perfume composition according to the invention will not comprise any fragrances from the following group of compounds of known allergenic potential. However, the underlined compounds represent a particular exception here as they are rose fragrances and their use, especially in small amounts, appears to be tolerable in some cases on account of their particular olfactory properties (also see above):

amylcinnamaldehyde, amylcinnamyl alcohol, anisyl alcohol, benzaldehyde, benzyl alcohol, benzyl benzoate, benzyl cinnamate, benzyl salicylate, citral, citronellol, coumarin, eugenol, farnesol, geraniol, hexylcinnamaldehyde, hydroxycitronellal, isoeugenol, lilial, limonene, linalool, lyral, methyl heptynecarbonate, methylionone, methyl octynecarbonate, cinnamaldehyde, cinnamyl alcohol, and natural products such as ethereal oils or other extracts containing these compounds in an effective amount.

Surprisingly, the compounds 4,8-dimethyl-7-nonen-2-one and 4,8-dimethylnonan-2-one and mixtures thereof are capable of modifying the olfactory properties of a mixture of the other constituents of the perfume composition to the extent that the composition acquires more body, particularly in the top note, the rose-like naturalness and the fresh-flowery note being distinctly strengthened. The mixtures are markedly harmonized by their soft rose/geranium-like character, fresh-green top notes, in particular, being aesthetically incorporated into the composition. The slightly citrus-like olfactory aspects of 4,8-dimethyl-7-nonen-2-one and 4,8-dimethylnonan-2-one, somewhat reminiscent of lemon, which although not dominant are nevertheless important, are additionally such that the olfactory character of many compositions is lightened and thus has a tangier and livelier effect.

The proportion of 4,8-dimethyl-7-nonen-2-one, 4,8-dimethylnonan-2-one or mixtures thereof in a perfume composition can be varied within wide limits. It conventionally ranges from 0.1 to 90 wt. %, but advantageously from 0.5 to 70 wt. %, based in each case on the total weight of the perfume composition.

The present invention further relates to a perfumed product comprising a perfume composition according to the invention.

Finally, the invention further relates to a process for producing a rose odour or strengthening the rose odour of a perfume composition or perfumed product, the rose odour not being accompanied by a coconut olfactory note. In the process a sensorially effective amount of 4,8-dimethyl-7-nonen-2-one, 4,8-dimethylnonan-2-one or a mixture of these compounds is mixed with the other constituents of the perfume composition or added to the product.

Preferred embodiments of the uses, perfume compositions, perfumed products and processes according to the invention can be found in the following explanations, the Examples and the attached Claims. It is understood that preferred forms mentioned for the perfume composition according to the invention also apply correspondingly to perfumed products according to the invention and to uses and processes according to the invention.

The compounds 4,8-dimethyl-7-nonen-2-one and 4,8-dimethylnonan-2-one can be prepared by the selective hydrogenation of 4,8-dimethyl-3,7-nonadien-2-one. An appropriate choice of hydrogenation conditions makes it possible selectively to prepare firstly 4,8-dimethyl-7-nonen-2-one and then, by further hydrogenation, 4,8-dimethylnonan-2-one. The 4,8-dimethyl-3,7-nonadien-2-one used as starting material can be prepared according to the instructions given e.g. in DE 2256347 C3 and DE 19961030 A1.

Examples of suitable hydrogenation catalysts for the selective hydrogenation are Raney nickel and palladium-on-charcoal. The ratio of catalyst to substrate will advantageously be between 0.005:1 and 0.1:1, the preferred ratio ranging between 0.01:1 and 0.0:1. The hydrogenation temperature preferably ranges between 0 and 50° C., the particularly preferred range being 20-40° C. The hydrogen pressure in the selective hydrogenation is advantageously between 1 and 150 bar, the preferred range being between 1 and 40 bar. The hydrogenation can be carried out without a solvent or in the presence of a suitable solvent.

On account of their aforesaid sensory properties, the ketones 4,8-dimethyl-7-nonen-2-one and 4,8-dimethylnonan-2-one are outstandingly suitable for use in perfume compositions. As already mentioned, they can be used as individual substances or in combinations with one another in a large number of products. It is particularly advantageous to combine them with other fragrances in different, varying proportions to form novel perfume compositions.

Even in small doses, the compounds 4,8-dimethyl-7-nonen-2-one and 4,8-dimethylnonan-2-one are capable of achieving effects of pronounced naturalness, the overall olfactory impression being strengthened and harmonized and the emanation and diffusivity being perceptively increased. It is particularly surprising here that the compounds on the one hand have a strengthening effect in the direction of freshness/radiance, but on the other hand also have a harmonizing effect.

Examples of preferred fragrances with which the compounds 4,8-dimethyl-7-nonen-2-one and 4,8-dimethylnonan-2-one can be combined have already been mentioned above. Other fragrances which are quite generally suitable for combination can be found e.g. in S. Arctander, Perfume and Flavor Materials, Vol. I and II, Montclair, N. J., 1969, Selbstverlag or K. Bauer, D. Garbe and H. Surburg, Common Fragrance and Flavor Materials, 4th Ed., Wiley-VCH, Weinheim 2001. The following may be specifically mentioned:

extracts of natural raw materials, such as ethereal oils, concrete oils, absolute essences, resins, resinoids, balsams, tinctures, e.g.:

ambergris tincture; amyris oil; angelica seed oil; angelica root oil; anise oil; baldrian oil; basil oil; tree moss absolute; bay oil; mugwort oil; benzoin resin; bergamot oil; beeswax absolute; birch tar oil; bitter almond oil; savory oil; buchu leaf oil; cabreuva oil; cade oil; calmus oil; camphor oil; cananga oil; cardamom oil; cascarilla oil; cassia oil; cassia absolute; castoreum absolute; cedar leaf oil; cedarwood oil; cistus oil; citronella oil; lemon oil; copaiva balsam; copaiva balsam oil; coriander oil; costus root oil; cumin oil; cypress oil; davana oil; dill oil; dill seed oil; eau de brouts absolute; oak moss absolute; elemi oil; tarragon oil; eucalyptus citriodora oil; eucalyptus oil; fennel oil; pine needle oil; galbanum oil; galbanum resin; geranium oil; grapefruit oil; guaiacum wood oil; gurjun balsam; gurjun balsam oil; helichrysum absolute; helichrysum oil; ginger oil; iris root absolute; iris root oil; jasmine absolute; calamus oil; blue camomile oil; Roman camomile oil; carrot seed oil; cascarilla oil; Scotch fir oil; spearmint oil; caraway oil; ladanum oil; ladanum absolute; ladanum resin; lavandin absolute; lavandin oil; lavender absolute; lavender oil; lemongrass oil; lovage oil; distilled lime oil; pressed lime oil; linaloa oil; litsea cubeba oil; laurel leaf oil; mace oil; majoram oil; mandarin oil; massoi bark oil; mimosa absolute; ambrette oil; musk tincture; muscatel sage oil; nutmeg oil; myrrh absolute; myrrh oil; myrtle oil; clove leaf oil; clove blossom oil; neroli oil; frankincense absolute; frankincense oil; opopanax oil; orange blossom absolute; orange oil; oreganum oil; palmarosa oil; patchouli oil; perilla oil; Peruvian balsam oil; parsley leaf oil; parsley seed oil; petitgrain oil; peppermint oil; pepper oil; pimento oil; pine oil; European pennyroyal oil; rose absolute; rosewood oil; rose oil; rosemary oil; Dalmatian sage oil; Spanish sage oil; sandalwood oil; celery seed oil; lavender spike oil; Japanese anise oil; styrax oil; tagetes oil; fir needle oil; tea tree oil; turpentine oil; thymian oil; tolu balsam; tonka absolute; tuberose absolute; vanilla extract; violet leaf absolute; verbena oil; vetiver oil; juniper oil; wine yeast oil; wormwood oil; wintergreen oil; ylang oil; hyssop oil; civet absolute; cinnamon leaf oil; cinnamon bark oil; and fractions thereof or ingredients isolated therefrom.

If said substances include compounds with sensitizing/allergizing properties, the above remarks apply correspondingly.

individual fragrances from the following groups:

hydrocarbons, e.g. 3-carene; α-pinene; β-pinene; α-terpinene; γ-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;

aliphatic alcohols, e.g. hexanol; octanol; 3-octanol; 2,6-dimethylheptanol; 2-methyl-2-heptanol; 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;

aliphatic aldehydes and their acetals, e.g. hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethyl acetal; 1,1-dimethoxy-2,2,5-trimethyl-4-hexene; citronellyloxyacetaldehyde; 1-(1-methoxypropoxy)-(E/Z)-3-hexene;

aliphatic ketones and their oximes, e.g. 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;

aliphatic sulfur-containing compounds, e.g. 3-methyl-thiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;

aliphatic nitriles, e.g. 2-nonenoic acid nitrile; 2-undecenoic acid nitrile; 2-tridecenoic acid nitrile; 3,12-tridecadienoic acid nitrile; 3,7-dimethyl-2,6-octadienoic acid nitrile; 3,7-dimethyl-6-octenoic acid nitrile;

esters of aliphatic carboxylic acids, e.g. (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl 2-methylpentanoate; ethyl hexanoate; allyl hexanoate; ethyl heptanoate; allyl heptanoate; ethyl octanoate; ethyl (E,Z)-2,4-decadienoate; methyl 2-octynate; methyl 2-nonynate; allyl 2-isoamyloxyacetate; methyl 3,7-dimethyl-2,6-octadienoate; 4-methyl-2-pentyl crotonate;

acyclic terpene alcohols, e.g. citronellol; geraniol; nerol; linalool; lavadulol; nerolidol; farnesol; tetrahydrolinalool; tetrahydrogeraniol; 2,6-dimethyl-7-octen-2-ol; 2,6-dimethyloctan-2-ol; 2-methyl-6-methylen-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and their formates, acetates, propionates, isobutyrates, butyrates, isovalerates, pentanoates, hexanoates, crotonates, tiglates, 3-methyl-2-butenoates;

acyclic terpene aldehydes and ketones, e.g. geranial; neral; citronellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal;

cyclic terpene alcohols, e.g. menthol; isopulegol; alpha-terpineol; terpinen-4-ol; menthan-8-ol; menthan-1-ol; menthan-7-ol; borneol; isoborneol; linalool oxide; nopol; cedrol; ambrinol; vetiverol; guaiol; and their formates, acetates, propionates, isobutyrates, butyrates, isovalerates, pentanoates, hexanoates, crotonates, tiglates, 3-methyl-2-butenoates;

cyclic terpene aldehydes and ketones, e.g. menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedarwood oil (methyl cedryl ketone);

cyclic alcohols, e.g. 4-tert-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;

cycloaliphatic alcohols, e.g. alpha-3,3-trimethylcyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-tri-methylcyclohexyl)hexan-3-ol;

cyclic and cycloaliphatic ethers, e.g. cineol; cedryl methyl ether; cyclododecyl methyl ether; 1,1-dimethoxycyclododecane; (ethoxymethoxy)cyclododecane; alpha-cedrene epoxide; 3a,6,6,9a-tetramethyldodecahydronaphtho[2,1-b]-furan; 3a-ethyl-6,6,9a-trimethyldodecahydronaphtho[2,1-b]-furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;

cyclic and macrocyclic ketones, e.g. 4-tert-butyl-cyclohexanone; 2,2,5-trimethyl-5-pentylcyclopentanone*; 2-heptylcyclopentanone*; 2-pentylcyclopentanone*; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone;

cycloaliphatic aldehydes, e.g. 2,4-dimethyl-3-cyclohexenecarbaldehyde; 2-methyl-4-(2,2,6-trimethylcyclohexen-1-yl)-2-butenal; 4-(4-hydroxy-4-methylpentyl)-3-cyclohexenecarbaldehyde; 4-(4-methyl-3-penten-1-yl)-3-cyclohexenecarbaldehyde;

cycloaliphatic ketones, e.g. 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl 2,6,10-trimethyl-2,5,9-cyclododecatrienyl ketone; tert-butyl 2,4-dimethyl-3-cyclohexen-1-yl ketone;

esters of cyclic alcohols, e.g. 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5- or 6-indenyl acetate; 4,7-methano-3a,4,5,6,7,7a-hexahydro-5- or 6-indenyl propionate; 4,7-methano-3a,4,5,6,7,7a-hexahydro-5- or 6-indenyl isobutyrate; 4,7-methanooctahydro-5- or 6-indenyl acetate;

esters of cycloaliphatic alcohols, e.g. 1-cyclohexylethyl crotonate; esters of cycloaliphatic carboxylic acids, e.g. allyl 3-cyclohexylpropionate; allyl cyclohexyloxyacetate; cis- and trans-methyl dihydrojasmonate; cis- and trans-methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolan-2-acetate;

araliphatic alcohols, e.g. benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

esters of araliphatic alcohols and aliphatic carboxylic acids, e.g. benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate;

araliphatic ethers, e.g. 2-phenylethyl methyl ether; 2-phenylethyl isoamyl ether; 2-phenylethyl 1-ethoxyethyl ether; phenylacetaldehyde dimethyl acetal; phenylacetaldehyde diethyl acetal; hydratropaldehyde dimethyl acetal; phenylacetaldehyde glyceryl acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;

aromatic and araliphatic aldehydes, e.g. benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl)propanal; 2-methyl-3-(4-isobutylphenyl)propanal; 3-(4-tert-butylphenyl)-propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)-propanal;

aromatic and araliphatic ketones, e.g. acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; 2-benzofuranylethanone; 3-methyl-2-benzofuranylethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;

aromatic and araliphatic carboxylic acids and their esters, e.g. benzoic acid; phenylacetic acid; methyl benzoate; ethyl benzoate; hexyl benzoate; benzyl benzoate; methylphenyl acetate; ethylphenyl acetate; geranylphenyl acetate; phenylethylphenyl acetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;

aromatic nitrogen-containing compounds, e.g. 2,4,6-trinitro-1,3-dimethyl-5-tert-butylbenzene; 3,5-dinitro-2,6-dimethyl-4-tert-butylacetophenone; cinnamic acid nitrile; 3-methyl-5-phenyl-2-pentenoic acid nitrile; 3-methyl-5-phenylpentanoic acid nitrile; methyl anthranilate; methyl N-methyl-anthranilate; Schiff bases of methyl anthranilate with 7-hydroxy-3,7-dimethyloctanal, 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; 2-(3-phenylpropyl)pyridine; indole; skatole; 2-methoxy-3-isopropylpyrazine; 2-isobutyl-3-methoxypyrazine;

phenols, phenyl ethers and phenyl esters, e.g. estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)-phenol; p-cresylphenyl acetate;

heterocyclic compounds, e.g. 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

lactones, e.g. 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3-dihydrocoumarin*; octahydrocoumarin*.

Note: The substances marked with an * in the above list have a coconut odour and therefore are only used in particular cases in combination with 4,8-dimethyl-7-nonen-2-one or 4,8-dimethylnonan-2-one. Compounds which have a sensitizing/allergizing effect and whose use is therefore only advantageous in particular cases have again been underlined.

Each combinations are preferred and which are less advantageous can be seen especially from the above remarks. Accordingly, combination with rose fragrances is particularly preferred, whereas combination with allergenic fragrances is less advantageous (even if these are themselves rose fragrances, e.g. citronellol and geraniol).

The amount of the two ketones according to the invention used in perfume compositions is 0.01 to 99.9 wt. %, preferably 0.1 to 90% and particularly preferably 0.5 to 70%, based in each case on the total perfume oil composition.

Perfume oils containing 4,8-dimethyl-7-nonen-2-one and 4,8-dimethylnonan-2-one can be used for perfume formulations in liquid form, either undiluted or diluted with a solvent. Examples of suitable solvents for this purpose are ethanol, isopropanol, diethylene glycol monoethyl ether, glycerol, propylene glycol, 1,2-butylene glycol, dipropylene glycol, diethyl phthalate, triethyl citrate, isopropyl myristate, etc.

Perfume oils containing the two ketones according to the invention can also be adsorbed on a carrier to ensure both a fine distribution of the fragrances in the product and a controlled release when used. Such carriers can be porous inorganic materials, such as light sulfate, silica gels, zeolites, gypsums, clays, clay granules, gas concrete, etc., or organic materials, such as woods, cellulose-based substances, sugars or plastics like PVC, polyvinyl acetates or polyurethanes.

Perfume oils containing the two ketones according to the invention can also be microencapsulated or spray-dried or in the form of inclusion complexes or extrusion products, and can be added in this form to the product to be perfumed.

Optionally the properties of the perfume oils modified in this way can be further optimized, in respect of a more specific perfume release, by coating with suitable materials; waxy plastics, e.g. polyvinyl alcohol, are preferably used for this purpose.

Microencapsulation of the perfume oils can be effected for example by the so-called coacervation process with the aid of capsule materials made e.g. of polyurethane-like substances or soft gelatin. Spray-dried perfume oils can be prepared for example by spray drying an emulsion or dispersion containing the perfume oil, it being possible for modified starches, proteins, dextrin and vegetable gums to be used as carriers. Inclusion complexes can be prepared for example by introducing dispersions of the perfume oil and cyclodextrins or urea derivatives into a suitable solvent, e.g. water. Extrusion products can be obtained by melting the perfume oils with a suitable waxy substance and by extrusion with subsequent solidification, optionally in a suitable solvent, e.g. isopropanol.

Perfume oils containing the two ketones according to the invention can be used in concentrated form, in solution or in a modified form described above for the preparation of e.g. perfume extracts, eaux de parfum, eaux de toilette, after-shave lotions, eaux de Cologne, pre-shave products, splash colognes and perfumed refreshing tissues, and for the perfuming of acidic, alkaline and neutral cleaning products, e.g. floor cleaners, window cleaners, dishwasher detergent, bath and sanitaryware cleaners, scouring cream, solid and liquid WC cleaners, carpet cleaning powders and foams, fabric fresheners, ironing aids, liquid detergents, powder detergents, fabric preconditioners such as bleach, soaker and stain removers, fabric softeners, washing soaps, washing tablets, disinfectants, surface disinfectants, air purifiers in liquid or gel form or applied to a solid carrier, aerosol sprays, waxes and polishes, such as furniture polishes, floor waxes and shoe polishes, body care products, e.g. solid and liquid soaps, shower gels, shampoos, shaving soaps, shaving foams, bath oils, cosmetic emulsions of the oil-in-water, water-in-oil and water-in-oil-in-water type, such as skin creams and lotions, face creams and lotions, sun creams and lotions, after-sun creams and lotions, hand creams and lotions, foot creams and lotions, depilatory creams and lotions, after-shave creams and lotions, tanning creams and lotions, hair care products, e.g. hair sprays, hair gels, strengthening hair lotions, hair rinses, permanent and semipermanent hair dyes, hair styling products, such as cold waving and straightening products, hair tonics, hair creams and lotions, deodorants and anti-perspirants, e.g. armpit sprays, roll-ons, deodorant sticks and deodorant creams, decorative cosmetic products, e.g. eye shadows, nail varnishes, make-ups, lipsticks and mascara, and candles, lamp oils, incense sticks, insecticides, repellents and propellants.

The invention is illustrated in greater detail below by means of Examples:

### EXAMPLE 1

### Preparation of 4,8-dimethyl-7-nonen-2-one by the hydrogenation of 4,8-dimethyl-3,7-nonadien-2-one

116.2 g of 4,8-dimethyl-3,7-nonadien-2-one (cf. DE 2256347 C3, DE 19961030 A1) are dissolved in 150 ml of ethyl acetate and hydrogenated in the presence of 7 g of Raney nickel in a 1 l steel autoclave at a temperature of 30 to 35° C. and a hydrogen pressure of 30 bar. When approx. 1.2 mol equivalents of hydrogen have been taken up, all the 4,8-dimethyl-3,7-nonadien-2-one has been converted. The hydrogenation is stopped, the catalyst is filtered off, the solvent is distilled off and the 4,8-dimethyl-7-nonen-2-one is isolated in pure form from the resulting crude product by fractionation in a Spaltrohr® column (manufactured by Fischer Labor—und Verfahrenstechnik GmbH). Yield 90 g (77% of theory), b.p. 63° C. at 0.2 mbar.

Odour: radiantly rose-like, natural, reminiscent of tea roses, citronellol-like, geranium-like

### EXAMPLE 2

### Preparation of 4,8-dimethylnonan-2-one by the hydrogenation of 4,8-dimethyl-3,7-nonadien-2-one

In a reaction set-up such as that described in Example 1, the hydrogenation was carried out at a pressure of 50 bar until 2 mol equivalents of hydrogen had been taken up. After the work-up, 4,8-dimethylnonan-2-one was obtained in pure form from the crude product by fractionation in a Spaltrohr® column. Yield 107 g (90% of theory), b.p. 58° C. at 0.4 mbar.

Odour: fresh, rose-like, somewhat citric-lemony, citronellol-like

### EXAMPLE 3

### Preparation of a Perfume with a Rose-Like Scent using 4,8-dimethyl-7-nonen-2-one and 4,8-dimethylnonan-2-one

Firstly the following are mixed:

| Fragrance | Parts by weight |
|---|---|
| 10-Undecenal | 2 |
| Datilat H&R (1-cyclohexylethyl crotonate) | 15 |
| 9-Decenol | 1 |
| Eugenol | 5 |
| Guaiacum wood oil | 7 |
| Indoflor H&R (2,4-dimethyl-5,6-indeno-1,3- | |
| dioxane) | 2 |
| alpha-Ionone | 20 |
| beta-Ionone | 7 |
| Cyclohexadecanone | 17 |
| Phenylacetaldehyde 10 percent in dipropylene | |
| glycol | 7 |
| Pyroprunat H&R (2 cyclopentylcyclopentyl | |
| crotonate) | 10 |
| Rose oxide 10 percent in dipropylene glycol | 7 |
| | 100 |

The addition of 125 parts by weight of 4,8-dimethyl-7-nonen-2-one and 125 parts by weight of 4,8-dimethylnonan-2-one gives a perfume oil with a fresh, radiant and modern rose note, which is outstandingly suitable for perfuming cleaners, fabric softeners, washing powders, air purifiers, soaps, shampoos, bath additives, skin creams, body lotions, deodorants and other cosmetics.

### EXAMPLE 4

### Preparation of a Perfume with a Rose-Like Scent using 4,8-dimethyl-7-nonen-2-one

The following are mixed:

| Fragrance | Parts by weight |
|---|---|
| 10-Undecenal | 2 |
| Datilat H&R (1-cyclohexylethyl crotonate) | 15 |
| 9-Decenol | 1 |
| Eugenol | 5 |
| Guaiacum wood oil | 7 |
| Indoflor H&R (2,4-dimethyl-5,6-indeno-1,3- | |
| dioxane) | 2 |
| alpha-Ionone | 20 |
| beta-Ionone | 7 |
| Cyclohexadecanone | 17 |
| Phenylacetaldehyde 10 percent in dipropylene | |
| glycol | 7 |
| Pyroprunat H&R (2-cyclopentylcyclopentyl | |
| crotonate) | 10 |
| Rose oxide 10 percent in dipropylene glycol | 7 |
| | 100 |

The addition of 50 parts by weight of 4,8-dimethyl-7-nonen-2-one gives a perfume oil with an extremely natural tea rose-like olfactory note, which is likewise outstandingly suitable for perfuming cleaners, fabric softeners, washing powders, air purifiers, soaps, shampoos, bath additives, skin creams, body lotions, deodorants and other cosmetics.

1. A method of imparting a rose odour to a composition that is not accompanied by a coconut olfactory note by adding to said composition 4,8-dimethyl-7-nonen-2-one, 4,8-dimethylnonan-2-one or a mixture of these compounds.

2. A method according to claim 1 wherein said composition is a perfume.

3. A method of imparting a rose odour to a composition wherein 4,8-dimethylnonan-2-one is added to said composition as a fragrance.

4. Perfume composition with a rose odour, comprising
an organoleptically effective amount of 4,8-dimethyl-7-nonen-2-one, 4,8-dimethylnonan-2-one or a mixture of these compounds, and
at least one other fragrance.

5. Perfume composition according to claim 4 wherein the other fragrance is selected from the group comprising:
geranyl formate; geranyl acetate; geranyl propionate; geranyl isobutyrate; geranyl butyrate; geranyl isovalerate; geranyl tiglate; geranyl benzoate; citronellyl formate; citronellyl acetate; citronellyl propionate; citronellyl isobutyrate; citronellyl butyrate; citronellyl isovalerate; citronellyl tiglate; citronellyl benzoate; phenylethyl alcohol; phenylacetaldehyde; phenylacetaldehyde dimethyl acetal; phenylethyl formate; phenylethyl acetate; phenylethyl propionate; phenylethyl isobutyrate; phenylethyl butyrate; phenylethyl pivalate; phenylethyl isovalerate; phenylethyl 2-ethylbutyrate; phenylethyl tiglate; phenylethyl benzoate; phenylethylphenyl acetate; 2-phenoxyethyl isobutyrate; geranyl methyl ether; rose oxide; phenylethyl methyl ether; phenylethyl ethyl ether; phenylethyl isoamyl ether; 2-methoxybenzyl ethyl ether; α-trichloromethylbenzyl acetate; α,3,3-trimethylcyclohexanemethyl acetate; 2,4,6-trimethyl-3-cyclohexenemethanol; 2-ethylhexanoic acid N,N-diethylamide; 3,7-dimethyloctanol; geranylacetone; linalool; 3,7-dimethyl-1,6-nonadien-3-ol; nerolidol; farnesol; 9-decenol; 9-decenyl acetate; decanal; 10-undecanal; 10-undecenol; citronellyloxyacetaldehyde; 3,7-dimethyloctanylacetaldehyde; 2-methyl-5-phenylpentanol; 2-methyl-5-phenylpentanal; 3-methyl-5-phenylpentanol; benzophenone; diphenyl ether; diphenylmethane; α-damascone; β-damascone; δ-damascone; γ-damascone; β-damascenone; 1-(2,4,4-trimethyl-2-cyclohexenyl)-2-buten-1-one; rose oil; rose absolute; geranium oil; palmarosa oil; lemon oil; patchouli oil; clove oil; ylang-ylang oil; jasmine absolute; ethyl 2,3,6-trimethylcyclohexyl carbonate; hexanal; heptanal; octanal; nonanal; hexanol; heptanol; octanol; nonanol; decanol; undecanol; dodecanol; hexyl acetate; heptyl acetate; octyl acetate; nonyl acetate; decyl acetate; undecyl acetate; dodecyl acetate; benzyl acetate; benzyl butyrate; benzyl benzoate; methylphenyl acetate; ethylphenyl acetate; alpha-terpineol; 4,4a,5,9b-tetrahydro-2,4-dimethylindeno[1,2-d]-m-dioxin; 4,4a,5,9b-tetrahydroindeno[1,2-d]-m-dioxin; ethyl 2-ethyl-6,6-dimethyl-2-cyclohexenecarboxylate; ethyl 2,3,6,6-tetramethyl-2-cyclohexenecarboxylate; ethyl safranate; methyl 6,6-dimethyl-2-methylenecyclohexanecarboxylate; eugenol; isoeugenol; lavender oil; guaiacum wood oil; alpha-ionone; beta-ionone; cinnamyl alcohol; 3-phenylpropanol; cinnamyl acetate; 3-phenylpropyl acetate; alpha-irone; cis-3-hexenol; cis-3-hexenyl acetate; cis-3-hexenyl isobutyrate; vanillin; ethylvanillin; heliotropin; coumarin; ambrinol; indole; 3a,6,6,9a-tetramethyldodecahydronaphtho[2,1-b]furan; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone.

6. Perfume composition according to claim 4 wherein the other fragrance is selected from the group of fragrances with a rose odour comprising:
geranyl formate; geranyl acetate; geranyl propionate; geranyl isobutyrate; geranyl butyrate; geranyl isovalerate; geranyl tiglate; geranyl benzoate; citronellyl formate; citronellyl acetate; citronellyl propionate; citronellyl isobutyrate; citronellyl butyrate; citronellyl isovalerate; citronellyl tiglate; citronellyl benzoate; phenylethyl alcohol; phenylacetaldehyde; phenylacetaldehyde dimethyl acetal; phenylethyl formate; phenylethyl acetate; phenylethyl propionate; phenylethyl isobutyrate; phenylethyl butyrate; phenylethyl pivalate; phenylethyl isovalerate; phenylethyl 2-ethylbutyrate; phenylethyl tiglate; phenylethyl benzoate; phenylethylphenyl acetate; 2-phenoxyethyl isobutyrate; geranyl methyl ether; rose oxide; phenylethyl methyl ether; phenylethyl ethyl ether; phenylethyl isoamyl ether; 2-methoxybenzyl ethyl ether; α-trichloromethylbenzyl acetate; α,3,3-trimethylcyclohexanemethyl acetate; 2,4,6-trimethyl-3-cyclohexenemethanol; 2-ethylhexanoic acid N,N-diethylamide; 3,7-dimethyloctanol; geranylacetone; linalool; 3,7-dimethyl-1,6-nonadien-3-ol; nerolidol; farnesol; 9-decenol; 9-decenyl acetate; decanal; 10-undecanal; 10-undecenol; citronellyloxyacetaldehyde; 3,7-dimethyloctanylacetaldehyde; 2-methyl-5-phenylpentanol; 2-methyl-5-phenylpentanal; 3-methyl-5-phenylpentanol; benzophenone; diphenyl ether; diphenylmethane; α-damascone; β-damascone; δ-damascone; γ-damascone; 62 -damascenone; 1-(2,4,4-trimethyl-2-cyclohexenyl)-2-buten- 1-one; rose oil; rose absolute; geranium oil.

7. Perfume composition according to one of claim 4, characterized in that it does not contain fragrances selected from the group comprising:
amylcinnamaldehyde, amylcinnamyl alcohol, anisyl alcohol, benzaldehyde, benzyl alcohol, benzyl benzoate, benzyl cinnamate, benzyl salicylate, citral, citronellol, coumarin, eugenol, farnesol, geraniol, hexylcinnamaldehyde, hydroxycitronellal, isoeugenol, lilial, limonene, linalool, lyral, methyl heptynecarbonate, methylionone, methyl octynecarbonate, cinnamaldehyde, cinnamyl alcohol, and natural products containing these compounds in an effective amount.

8. Perfume composition according to one of claim 4, containing 4,8-dimethyl-7-nonen-2-one, 4,8-dimethylnonan-2-one or a mixture of these compounds in an amount which modifies the olfactory properties of a mixture of the other constituents of the perfume composition in the direction of freshness and/or radiance.

9. Perfume composition according to one of claim 4, characterized in that the proportion of 4,8-dimethyl-7-nonen-2-one, 4,8-dimethylnonan-2-one or a mixture of these compounds ranges from 0.1 to 90 wt. %, preferably from 0.5 to 70 wt. %, based on the total weight of the perfume composition.

10. Perfumed product comprising a perfume composition according to claim 4.

11. Process for producing a rose odour or strengthening the rose odour of a perfume composition or perfumed product, the rose odour not being accompanied by a coconut olfactory note, characterized in that a sensorially effective amount of 4,8-dimethyl-7-nonen-2-one, 4,8-dimethylnonan-2-one or a mixture of these compounds is mixed with the other constituents of the perfume composition or added to the product.
